(19) United States
(12) Patent Application Publication
(10) Pub. No.: US 2019/0050916 A1
(43) Pub. Date: Feb. 14, 2019

(54) SYSTEMS, DEVICES, AND METHODS FOR COMMUNICATING FOOD PRODUCT SLICE THICKNESSES

(71) Applicant: Robert W. BRUCE, Loveland, OH (US)

(72) Inventor: Robert W. BRUCE, Loveland, OH (US)

(21) Appl. No.: 16/159,106

(22) Filed: Oct. 12, 2018

Related U.S. Application Data
(63) Continuation-in-part of application No. 15/360,490, filed on Nov. 23, 2016.
(60) Provisional application No. 62/265,456, filed on Dec. 10, 2015.
(60) Provisional application No. 62/259,751, filed on Nov. 25, 2015.

(51) Int. Cl. G06Q 30/02; G01B 11/06; G06Q 50/12; G06Q 20/20

(52) U.S. Cl. CPC G06Q 30/0281; G06Q 20/208; G06Q 50/12; G01B 11/0608

(57) ABSTRACT

Systems, methods and slice thickness gauges that are capable of providing customers with identifying features representative of varying thicknesses of food products slices available for purchase, and with which customers can place orders for sliced food products having a desired slice thickness. The method includes providing a slice thickness gauge to a customer. The slice thickness gauge includes a plurality of identifying features each identifying feature corresponding to a thickness of a food product that may be produced by the attendant. The identifying features include a numeric value that is an integer devoid of fractions and decimal values and corresponds to a slice measurement that can be configured on a slicing machine.

### CROSS REFERENCE TO RELATED APPLICATIONS

This application claims the benefit of U.S. Provisional Application No. 62/259,751, filed Nov. 25, 2015, U.S. Provisional Application No. 62/265,456, filed Dec. 10, 2015 and U.S. application Ser. No. 15/360,490, filed Nov. 23, 2016. The contents of these prior applications are incorporated herein by reference.

### BACKGROUND OF THE INVENTION

The present invention generally relates to systems, methods and devices used in sales promotions. The invention particularly relates to sales display systems, devices, and methods that provide customers with identifying features representative of varying thicknesses of sliced food products available for purchase, and methods that accurately delivers the desired slice thickness, and significantly reduce time consumption of the purchasing process, and facilitating the customer to complete other shopping while the sliced product order at the delicatessen (deli) is being processed.

Placing an order for sliced product at a delicatessen (deli) counter is currently a time-consuming process, generally requiring the consumer to take a number from a dispenser and wait for their turn to be served. When it is their turn to be served, the customer is asked for the product they want, the slice thickness and how much of the product they wish to procure. The attendant/slicer operator then cuts a slice of some thickness, which is presented to the customer. This may be followed by a discussion over the interpretation of the customer's slice thickness description and a change in the setting of the slicing machine thickness setting, sometimes developing into an iterative process. The customer then has to generally repeat the total weight or number of slices requested. A desired improvement in the process of purchasing a sliced food product is reducing the time customers wait to have their order filled and receiving product slices close to the desired thickness.

Cutting and slicing machines of types used for slicing food products are commonly equipped with slice thickness settings that may be used by an operator to provide food product slices over a continuous range, for example, about 0 to about 17 mm (about 0 to about 0.5 inch). Because of the flexible nature of meats, cheeses, and certain other food products, the accuracy of the thickness setting may be within about plus or minus ten percent of the intended thickness. For example, a slicing machine having thickness settings of ½, 1, 1½, 2, 2½, 3 mm (about 0.020, 0.040, 0.060, 0.080, 0.100, and 0.120 inch) may produce food product slices in ranges of about 0.015 to 0.025, 0.045 to 0.055, 0.055 to 0.065, 0.075 to 0.085, 0.095 to 0.105, 0.125 to 0.135 inch or in metric 0.45 to 0.55, 0.9 to 1.1, 1.35 to 1.65, 0.18 to 2.2, 2.25 to 2.75, and 2.7 to 3.3 mm. Based on the skill of the operator and the continuously variable machine setting, any desirable thickness over the operating range of the equipment can generally be achieved.

Most, if not all, of the major slicing machine brands sell machines with such adjustment knobs fitted with an engineering thickness scale, sometimes described as a micrometer dial. However, many customers are unaccustomed to-, unfamiliar with-, or uncomfortable with such measurements in inches or millimeters as these may involve decimal points and fractions. For these reasons it may be desirable to use a color code based on the most familiar colors or the rainbow that are associated with integer numbers in thousandths of an inch as opposed to fractions or decimal numbers in the communication of slice thickness.

At delicatessen (deli) counters and sliced-meat departments in the U.S., the slice thicknesses of meats and cheeses are often described as shaved, very thin, thin, regular, medium, and thick. Because of the subjective nature of these descriptions, the attendant will sometimes show the customer a first slice of food product before slicing the entire order so that the customer may judge the thickness of the slice. Often this slice is offered as a free sample to the customer, but with a cost to the vendor. For example, with a median meat price $10/lb., ¼ lb. is $2.50, for 5 slices=$0.50 per slice. In a typical operation having five slicer operators each processing 2 orders in 10 minutes, 5 min./order plus one slice, 6 hours per day=5×12×6=360 slices=$180. This would represent a cost of $5,400/month. A slicer operator may use 1 minute of every 5 minutes to process an order to present a “thickness” slice to a customer, which is a 20% loss in efficiency. That is a workforce excess of one additional slicer operator. Typical slicer operators earn $8-$12 per hour. At an average of $10 per hour for 40 hours a week the excess workforce results in a cost of 10×$40×4=$1600/month. In addition to salary, additional costs for the excess workforce exist, including power consumption and cost of one slicing machine. Overall, the costs of the extra sliced product and excess workforce results in a cost of about $7,000/month per store. The result of this process is wasted time, additional costs for the vendor, and, potentially, dissatisfaction of the customer who still may not have received the exact thickness desired.

Accordingly, there is an ongoing desire for methods and means for communicating to customers the various thicknesses of food product slices available for purchase, and, in particular, methods and means that could avoid the additional cost and time involved in offering free samples to customers.

### BRIEF DESCRIPTION OF THE INVENTION

The present invention provides systems, methods and slice thickness gauges that are capable of providing customers with identifying features representative of varying thicknesses of food product slices available for purchase without necessitating the offering of free samples to the customers.

According to one aspect of the invention, a method for purchasing sliced food products from an attendant at a store counter. The method includes providing a slice thickness gauge to a customer. The slice thickness gauge includes a plurality of identifying features each identifying feature corresponding to a thickness of a food product that may be produced by the attendant. The identifying features include a numeric value that is an integer devoid of fractions and decimal values and corresponds to a slice measurement that can be configured on a slicer. A customer selection is communicated to the attendant in the form of a slip. The slip includes identification of the food product and the numeric value. One or both of the slip and the thickness gauge include a representation of the slice thickness. An acceptance of the slip is communicated to the customer. The order is validated in response to the identification of the food product and the numeric values for thickness and quantity ordered. Invalid and incomplete orders are communicated to the customer. The slicer is configured to slice the food product to a thickness corresponding to the numeric thickness value. The food product is retrieved from storage and sliced to the thickness corresponding to the numeric thickness value. The sliced food product is weighed and packaged. The price is determined based on the weight. The customer is notified that the food product is ready for retrieval. Remaining product is put back in storage.

According to another aspect of the invention, a slice thickness gauge includes a plurality of identifying features each having a thickness indicative of a thickness of a food product slice and means for individually identifying each of the plurality of identifying features.

According to another aspect of the invention, a method for purchasing food products provided in the form of one or more slices includes providing a device to a customer wherein the device has a plurality of identifying features each having a thickness representative of a thickness of which slices of the food products may be produced and means for individually identifying each of the plurality of identifying features. The customer compares the relative thicknesses of the plurality of identifying features, determines a desired thickness for slices of the food product based on the relative thicknesses of the plurality of identifying features, and communicates the desired thickness based on the identifying means. The food products may then be cut into slices such that the slices have a thickness based on the desired thickness communicated by the customer, either on a slicing machine fitted with a calibrated slice thickness adjustment knob or based on the attendant/slicer operator using a similar display as that used by the customer, or a micrometer.

According to another aspect of the invention, a food product ordering system comprises a device for placing an order for a sliced food product or a computer connected to the electronic device for receiving the order for the sliced food product. The device comprises a plurality of identifying features each having a thickness indicative of a slice thickness of the sliced food product, and means for selecting a food product, weight of the food product or number of slices, and one of the identifying features to select the slice thicknesses.

Technical effects of sales display systems, devices, and methods of types described above preferably include the ability to communicate available food product slice thicknesses to a customer without the need to provide the customer with a free slice of the food product and without the time consumption of this sometimes iterative process. Instead, the systems, devices, and methods enable a customer to compare the relative thicknesses of the identifying features of the device and then communicate the desired thickness of the food product slice to an attendant by making reference to the identifying features of the method. The identifying feature is a numerical value that is an integer devoid of fractions and decimal values and corresponds to a slice thickness measurement that can be configured on a slicer. Advantages of using such devices and methods include the increased likelihood that a customer will receive food product slices of the thickness desired by the customer, the ability to more easily and accurately interpolate and extrapolate slice thicknesses based on the measurements and coding provided on the devices, and the ability to more rapidly and accurately fill a customer's order with less time and effort required by the customer and attendant.

Other aspects and advantages of this invention will be further appreciated from the following detailed description.

### BRIEF DESCRIPTION OF THE DRAWINGS

FIG. 1 contains images representing slice thickness gauges capable of use in systems that can be used by customers to order food product slices of various thicknesses available for purchase in accordance with certain non-limiting aspects of this invention.

FIG. 2 represents photocopies of slice thickness gauges such as of a type shown in FIG. 1, and evidence the ability of a photocopy to be used in an essentially identical manner as the embodiments represented in FIG. 1.

FIG. 3 schematically represents a slip capable of use in systems that can be used by customers to order food product slices of various thicknesses available for purchase in accordance with additional non-limiting aspects of this invention.

FIG. 4 schematically represents a slip capable of use in systems that can be used by customers to order food product slices of various thicknesses available for purchase in accordance with additional non-limiting aspects of this invention.

FIG. 5 schematically represents a slip capable of use in systems that can be used by customers to order food product slices of various thicknesses available for purchase in accordance with additional non-limiting aspects of this invention.

FIG. 6 shows a representative display displayed to the customer in the preparation of an electronic slip according to an embodiment of the present invention.

FIG. 7 shows a representative display displayed to the customer in the preparation of an electronic slip according to an embodiment of the present invention.

Wherever possible, the same reference numbers will be used throughout the drawings to represent the same parts.

### DETAILED DESCRIPTION OF THE INVENTION

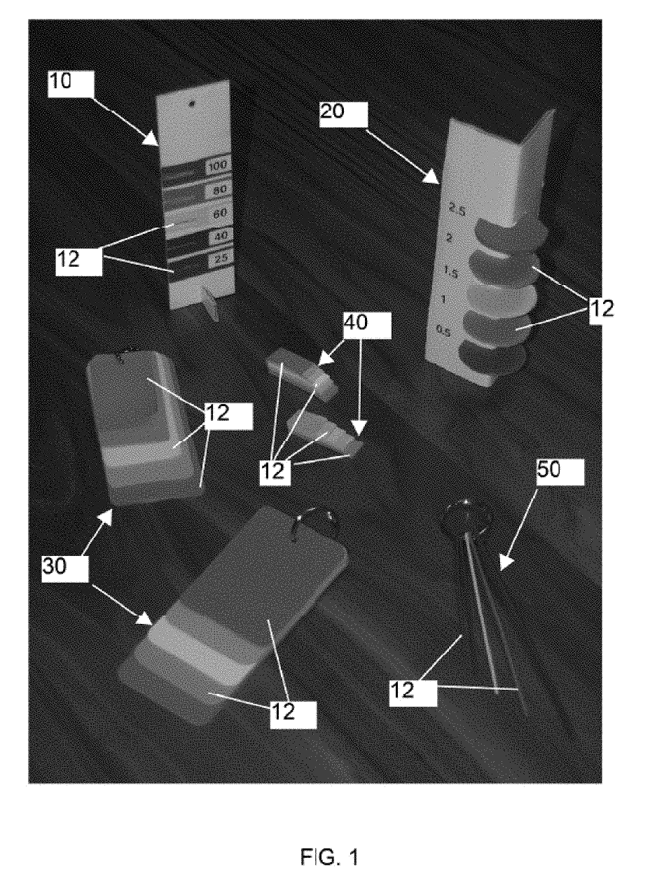

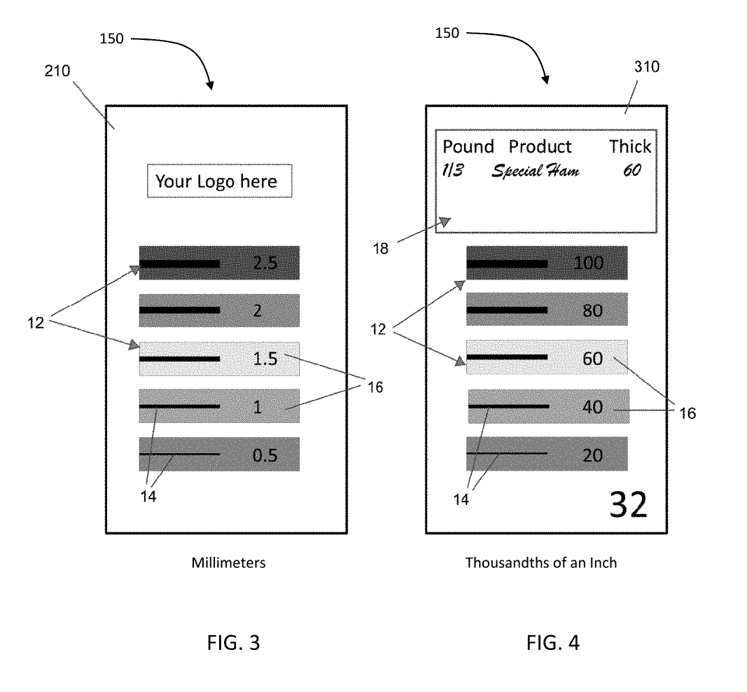

FIG. 1 represents various non-limiting embodiments of slice thickness gauges 10, 20, 30, 40, and 50 suitable for use in systems adapted to communicate to a customer various thicknesses of product slices available for purchase, for example at a deli counter or a sliced-meat department. These slice thickness gauges 10, 20, 30, 40, and 50 provide customers with the ability to gauge the thickness of a slice of food product prior to the product being sliced by an attendant. The slice thickness gauges 10, 20, 30, 40, and 50 are capable of communicating various available slice thicknesses visually, by touch, or both such that the customer may compare all available options. The slice thickness gauges 10, 20, 30, 40, and 50, as shown in FIGS. 1-3, include a representation of the slice thickness. By representation of the slice thickness, it is meant that the gauges may include a representation reflecting the actual and/or approximation of the thickness of the food product in a three-dimensional or two-dimensional manner. For example, as shown in FIG. 1, the food product slices may be simulated using a physical model of the slice of food product. Alternatively, as shown in FIG. 3, the food product slices can be simulated as a bar or slot in a photograph or picture of a slice of a food product, showing its thickness. In FIG. 3, these thickness bars are shown along with the associated color code and integer thickness number in thousands of an inch.

Upon determining a desired slice thickness, the customer may communicate the desired slice thickness to the attendant using a slip 150, as in FIGS. 3, 4, and 5, including identifying features 12 provided on the device 10, 20, 30, 40, and 50, or by providing the attendant with a portion of the device 10, 20, 30, 40, or 50 carrying one or more identifying features 12 indicative of the desired slice thickness. Alternatively, and particularly if the slice thickness adjuster of a slicing machine is not equipped with thickness indicators, the customer and attendant can make thickness comparisons using as references one or more slice thickness gauges 10, 20, 30, 40, and 50 of different thicknesses, which may avoid the practice of the attendant providing the customer with a sample slice. While the identifying features 12 of the slice thickness gauges 10, 20, 30, 40, and 50 are represented as having means for identifying individual slice thicknesses by color code and, also with numerical values and/or physical attributes, it is foreseeable that functionally-equivalent identifying means could be used to distinguish between the individual slice thicknesses, such as numbers, patterns, shapes, etc. In a particularly suitable embodiment, the identifying features 12 include a numeric value, as an indicia or tactile marking (e.g., Braille), that is an integer devoid of fractions and decimal values and corresponds to a slice measurement that can be configured on a slicing machine.

In one embodiment, FIG. 4, the slip 150 is an order form and the identifying features 12 include bands individually located within different color fields that function as the identifying means, the device further comprising an order number and a form field 18 within which the customer is able to write the identity, weight or number of slices desired, and slice thickness of the sliced food product, the order form being presentable to an attendant at a store counter to place an order for the sliced food product.

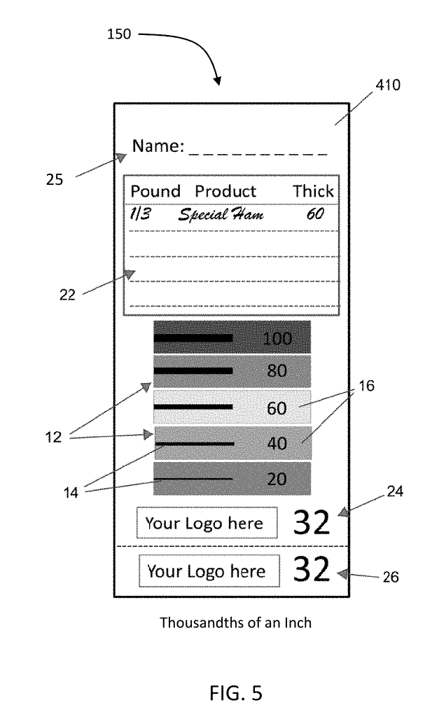

In one embodiment, the slice thickness gauge 10, 20, 30, 40, and 50 is provided as slip 150/210 of FIG. 3, or order form 150/310 of FIG. 4, or 150/410 of FIG. 5, and the identifying features are bands individually identified with the identifying means. The slip 150 further includes an order number and a form field within which the customer is able to write the identity, total weight of the order, or number of slices desired, and the desired slice thickness of the sliced food product. The customer uses the form field to identify the food product and the weight of the food product, and/or number of slices and selecting one of the identifying means to select the desired slice thickness. The customer presents the slip 150 to an attendant at a store counter electronically or via an electronic file to place an order for the sliced food product. The attendant or the slip 150 provides the order number 24 of slip 410 in FIG. 5, to confirm the order and notify the customer when there is a problem with the order, and when the order is filled. The method reduces waiting time of the customer at the counter.

In a particularly suitable embodiment, the customer indicates the desired thickness with a thickness scale corresponding with a thickness scale shown on the slicing machine slice-thickness adjustment knob for setting the thickness. The thickness scale may include a color code based on the most familiar colors of the rainbow that are associated with integer numbers in thousandths of an inch as opposed to fractions or decimal numbers in the communication of slice thickness. The colors of the rainbow may be used on order of wavelength, with red representing the greater thickness, followed by orange, yellow, green, blue and purple as the lowest thickness, corresponding with the sliced product description “shaved”. The thicknesses may be communicated in thousandths of an inch, for instance 20, 40, 60, 80, 100 and 120 thousandths of an inch. The customer may also interpolate or extrapolate by using different numbers, or by indicating a desired thickness in between certain colors, for instance: greater than red, the sum of red and orange, or a multiple of red.

The attendant/slicer operator uses a micrometer, a version of the proposed gauge, or a slicing machine with calibrated thickness knob/dial to provide the requested thickness. The attendant configures the slicing machine to a setting corresponding to the numerical value.

Regardless of the specific identifying features 12 and incorporated onto the slice thickness gauges 10, 20, 30, 40, and 50 shown in FIG. 1, the identifying features 12 are preferably aligned and arranged side by side on the gauges 10, 20, 30, 40, and 50 in a logical order, e.g., from thinnest to thickest, for comparison and to facilitate handling and communication. The identifying features 12 of the gauges 10, 20, 30, 40, and 50 include physical attributes individually associated with different colors. In particular, the identifying features 12 of the gauges 10, 20, 30, 40, and 50 include slots, disks, cards, tiers, and rods, respectively. The features 12 of the devices 20, 30 and 50 are separate articles held together in some manner, for example, with slots (device 20) or rings (devices 30 and 50), though other securement means are possible, for example, fasteners such as rivets, grommets, eyelets, staples, chains, glues, etc. The features 12 of the gauges 10 and 40 are integral physical attributes of single articles, for example, slots formed in a card (device 10) or tiers (device 40) machined, extruded, or otherwise formed to have different widths or thicknesses. By placing the features 12 in proximity to each other, a customer can easily compare their relative thicknesses and determine a desired product slice thickness. Colors that can be readily distinguished and identified include red, orange, yellow, green, blue, and purple, though other colors, combinations, patterns (such as checkered), etc., can be used. The colors of the features 12 are shown as arranged in the order of their wavelengths in the electromagnetic spectrum to promote the intuitiveness of the gauges 10, 20, 30, 40, and 50.

The features 12 of the gauges 10 and 20 further include numerical values to facilitate communication. The individual features 12 of the gauges 10, 20, 30, 40, and 50 may have any outline, shape, and/or dimensions that may be suitable under various circumstances. For example, an individual identifying feature 12 may have a size as small as 1×0.5 inch (about 2.5×1.3 cm), or as large as 6×2.5 inches (about 15×6.3 cm), with larger sizes facilitating the display of a logo or promotion.

The gauges 10, 20, 30, 40, and 50 are preferably formed of materials that can be cleaned, disposed of, recycled, or a combination thereof. Such materials include, but are not limited to, paper, polymers (for instance polyethylene, polypropylene, nylon, etc.), metals, and composite materials. The materials may be either a solid or foam. The gauges 10, 20, 30, 40, and 50 and their features 12 can be relatively small, low cost, and hygienic for advertising or promotion, while providing a simple means of effectively communicating a desired slice thickness among a range of slice thicknesses that may be available for slices of a particular food product. Paper devices may be of a use-once nature, plastic or metal devices may be fabricated from easily cleanable material so these devices may be cleaned along with the knives and other tools usually found in a deli.

As noted above, the display device 10 in FIG. 1 comprises a card, for example, a stand, rack, or other type of upright support, and its individual features 12 are slots formed along an edge of the card. In the non-limiting embodiment represented in FIG. 1, the slots range in width from about 0.020 to 0.100 inch (about 0.5 to 2.5 mm) wide. Each slot is located within a field or background of a specific color and number identifying the slot and a product slice thickness corresponding to the width of each slot. A customer may determine a desired slice thickness by inspecting the slots, and then communicate the desired slice thickness to an attendant by identifying the corresponding color or number. As evident from FIG. 1, the slots are arranged in a logical order of increasingly wider slots from bottom to top. Based on knowledge of this logical order, a customer may also communicate a desired slice thickness by requesting a thickness that is less than or greater than a particular field color or number associated with a slot, or a thickness that lies between a consecutive pair of field colors or numbers associated with a consecutive pair of slots.

The slice thickness gauge 20 in FIG. 1 also comprises a card, for example, a stand, rack, or other type of upright support. The gauge 20 differs in part from the device 10 as a result of the features 12 being in the form of disks of different colors and thicknesses protruding from the card, wherein each disk corresponds to a different product slice thickness. In the non-limiting embodiment represented in FIG. 1, the disks are indicated as having individual thicknesses ranging from about 0.5 to 3 mm (about 0.020 to 0.120 inch). Although represented as circular, the disks may be of any shape. The disks may be removable from the card, in which case the disks may be received in slots formed in the card and identified by different colors, numbers, patterns, etc., that preferably match the identifying aspects of the disks. As with the embodiment of FIG. 1, the disks are arranged in a logical order of increasingly thicker disks from bottom to top, enabling a customer to request a slice thickness that is less than or greater than a particular disk color or number or between a consecutive pair of disk colors or numbers. In FIG. 1, the disks are formed of a washable or otherwise cleanable plastic material.

As previously noted, the features 12 of two devices 30 represented in FIG. 1 are in the form of collections of cards or other sheet-like panels, each of a different color, size (e.g., lengths ranging from about 2.5 to about 6 inches (about 6 to 15 cm)), and thickness (e.g., ranging from about 0.020 to 0.120 inch (about 0.5 to 3 mm)), corresponding to different slice thicknesses that may be available. Thicknesses and/or other identifying information may be printed on each card. The cards are shown as loosely secured to one another with a ring (or similar securing means) that passes through a hole within each card, enabling each gauge 30 to be connected to a stationary object to prevent misplacement. As with previously described embodiments, the cards are arranged in a logical order, here increasingly thicker cards from top to bottom, to enable customers to request a slice thickness that is less than or greater than a particular card color (thickness) or between a consecutive pair of card colors (thicknesses). The cards may be formed of a wide variety of materials, including but not limited to cleanable plastic or metallic materials.

The features 12 of two devices 40 represented in FIG. 1 comprise tiers or other stack-like structures, each also having a different color, size (e.g., lengths ranging from about 0.5 to 2 inches (about 1.3 to 5 cm)), and thickness (e.g., ranging from 0.020 to 0.120 inch (about 0.5 to 3 mm), corresponding to different slice thicknesses that may be available. Numerical thicknesses and/or other identifying information may be printed on each tier. The tiers may be formed of a wide variety of materials, including, but not limited to, plastic or metallic materials. In the embodiment represented in FIG. 1, the tiers are panels, cards, or sheets that may be removable from one another and formed of a disposable or recyclable material, such that each device 40 may be intended for a single use. For example, the tiers may be made of paper sheets and locally adhesively secured to one another by glue or other securing means, peeled apart from each other during the course of assisting a customer, and discarded once the customer has made a purchase. As with previously described embodiments, the tiers are arranged in a logical order, here increasingly thicker tiers from top to bottom, to enable customers to request a slice thickness that is less than or greater than a particular tier color (thickness) or between a consecutive pair of tier colors (thicknesses).

The features 12 of the device 50 represented in FIG. 1 comprise a collection of rods, each with a different color, length, and thickness (e.g., ranging from 0.020 to 0.120 inch (about 0.5 to 3 mm)), corresponding to different slice thicknesses that may be available. Numeric thicknesses and/or other identifying information may be printed on each rod. The rods are shown as secured to one another with a ring that passes through a hole within each rod, enabling the device 50 to be connected to a stationary object to prevent misplacement. As with previously described embodiments, the rods are arranged in a logical order, here increasingly thicker rods from left to right, to enable customers to request a slice thickness that is less than or greater than a particular rod color (thickness) or between a consecutive pair of rod colors (thicknesses). The rods may be formed of a wide variety of materials, including, but not limited to, plastic or metallic materials.

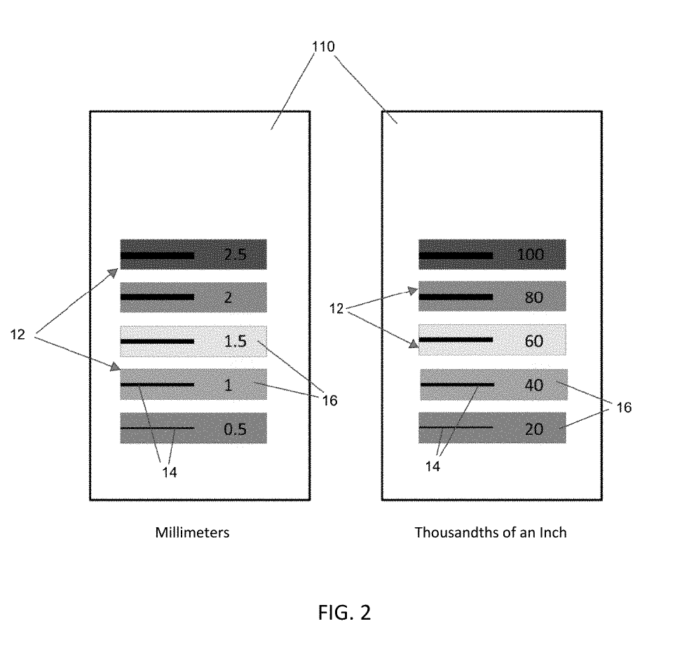

An image of any of the slice thickness gauges 10, 20, 30, 40, and 50 shown in FIG. 1 could also be used to communicate to a customer various thicknesses of product slices available for purchase. FIG. 2 shows two color photocopies 110 of two devices similar to the slice thickness gauge 10 of FIG. 1 produced with a standard photocopier on a sheet of white stock paper, and evidences that the photocopies 110 could be used as gauges in place of the original device 10. In place of the slots of the original device 10, the photocopies 110 can be produced with black paper overlaying the device 10 to result in black bands or bars 14 imaged from the slots in the original device 10. The black bands 14, which are located within the same color fields 16 used by the original device 10 as identifying means, can then be used to represent various thicknesses of product slices available for purchase. Though the photocopies 110 are preferably in color, it is foreseeable that a grayscale image could also be useful. The photocopies 110 shown in FIG. 2 could alternatively utilize black dots as the thickness indicating features 12. A readily apparent advantage of a photocopied image is the minimal cost of their reproduction, such that each photocopy 110 can be a single-use disposable item and/or part of an ordering slip 150.

It should be apparent from the foregoing that the slice thickness gauges 10, 20, 30, 40, and 50 and photocopies 110 are non-limiting examples of the present invention. It is foreseeable and within the scope of the invention that a slice thickness gauge could incorporate some or all of the various aspects of the gauges 10, 20, 30, 40, and 50, and/or may include indicating features 12 not represented in FIG. 1. The drawings disclose certain dimensions, materials, and structures for the various gauges 10, 20, 30, 40, and 50 that are exemplary, but are otherwise not necessarily limitations to the scope of the invention. While the gauges 10, 20, 30, 40, and 50 have been described as having specific thickness dimensions, it should be clear that theoretically any desired slice thickness between the disclosed thickness values and outside the stated thickness ranges can be achieved by interpolation and extrapolation.

In one embodiment, the present disclosure includes a food product ordering system including a device for placing an order for a sliced food product. The device includes a plurality of identifying features, each of the identifying features having a thickness indicative of a slice thickness of the sliced food product, the device further comprising a slip 150 for selecting a food product, weight of the food product or number of slices desired, and one of the identifying means to select one of the slice thicknesses. In addition, a computer may be wired to a terminal or wirelessly connected to an electronic device for receiving the order for the sliced food product.

In one embodiment, the method according to the present invention may include placing the complete order for processing, by a slip 150 or order form on a piece of paper, on a, terminal or on a handheld electronic device. In a particularly suitable embodiment, the customer selection is communicated to the attendant in the form of a slip 150. The communication to the attendant may be providing the physical slip 150 or in electronic form. In one embodiment, independent of the slice thickness gauges 10, 20, 30, 40, and 50, may include a representation of the slice thickness.

FIGS. 3 and 4 schematically represent handheld electronic devices 210 and 310, such as a cell phone or tablet device, that are capable of use in electronic ordering systems that can be used by customers to order food product slices of various thicknesses in accordance with additional non-limiting aspects of this invention. The electronic device 210 may be a touch pad or other handheld device by which a customer is able to select a slice thickness by selecting one of a number of displayed indicating features 12, each represented as a dark band or bar 14 within an identifying means comprising a color field 16 and identified with a numerical value for the slice thickness. In one embodiment, the identifying feature is specifically displayed as indicia representing the numeric value and at least one of colors, sizes, and logical order of the panels. The electronic device 310 further enables a customer to select the type and weight of a product to be purchased, which appear in a display 18 near the top of the device 310. With these devices 210 and 310, a computer system can be employed to facilitate electronic ordering. In some instances, a customer may enter their name and pay for their order at check out. Alternatively, a customer may enter their store membership number on the device 210 or 310 and pay for the sliced product at check out. The devices 210 and 310 may further incorporate a credit or debit card reader that enables a customer to pay for a sliced product when the order is placed. In each case, the time of the order can be automatically recorded. The display 18 on the device 310 may allow a customer to view a complete list of products in alphabetical order, categorized by type (e.g., beef, kosher, etc.), brands, conditions (e.g., rare, well done, etc.) and product availability. The devices 210 and 310 are preferably wirelessly connected to a computer that records the time when the order was placed, issues an order number, and optionally records the time that the order was filled. A printed confirmation of the order, including details such as time, order number, product, weight and/or number of slices, slice thickness, etc., may be printed so that the customer has a record of the purchase. When the customer's order is ready, the attendant can notify the customer using an order number (lower right-hand corner of FIG. 4) or the customer's name, either of which may be entered on the device 210 and/or 310.

Upon submitting the order, the order is confirmed and associated with an order number, validated and completion of the order is announced on a board and/or by public announcement system, or handheld device. The acceptance of the slip 150 is communicated to the customer. The communication of the acceptance may be orally, via a paper confirmation, via a store display or via an electronic notification, such as a text, email or application generated notification. For example, as shown in FIG. 5, the acceptance of the slip 150 may be simply providing the tear-off slip 26 to the customer.

After the acceptance of the slip 150, the order is validated in response to the identification of the food product and the numeric values. For example, a physical check of the inventory of the food product is checked for the type, quality and quantity of product. An invalid order, as communicated by the slip 150, may be insufficient product, or product that is out of the desired specification. Invalid or incomplete orders are communicated to the customer. The communication of the invalid order may be orally, via a paper confirmation, via a store display or via an electronic notification, such as a text, email or application generated notification.

Certain features of the devices 210 and 310 described above can be realized without the use of a computer, for example, through a device 410 represented in FIG. 5 as an order form on which a customer can select a slice thickness by selecting one of a number of indicating features 12, each represented as a dark band or bar 14 within an identifying means comprising a color field 16 and identified with a numerical value for the slice thickness. The customer can enter their name and write down the product, weight, slice thickness, etc., in form fields 25 and 22, after which the device 410 can simply be given to an attendant to process the order. The slip 150 can incorporate an order number 24 and may have a tear-off strip 26 with the same order number that the customer can retain after submitting the order form to an attendant. A time stamp (not shown) may also be incorporated on the form. When the customer's order is ready, the attendant can notify the customer using the order number 24 or customer's name in form field 25 that was entered on the device 410. It should be appreciated that, though the device 410 does not have all of the conveniences of the electronic devices 210 and 310, all three devices 210, 310 and 410 are capable of greatly reducing waiting time at a deli counter or sliced-meat department, providing the user more time for further shopping.

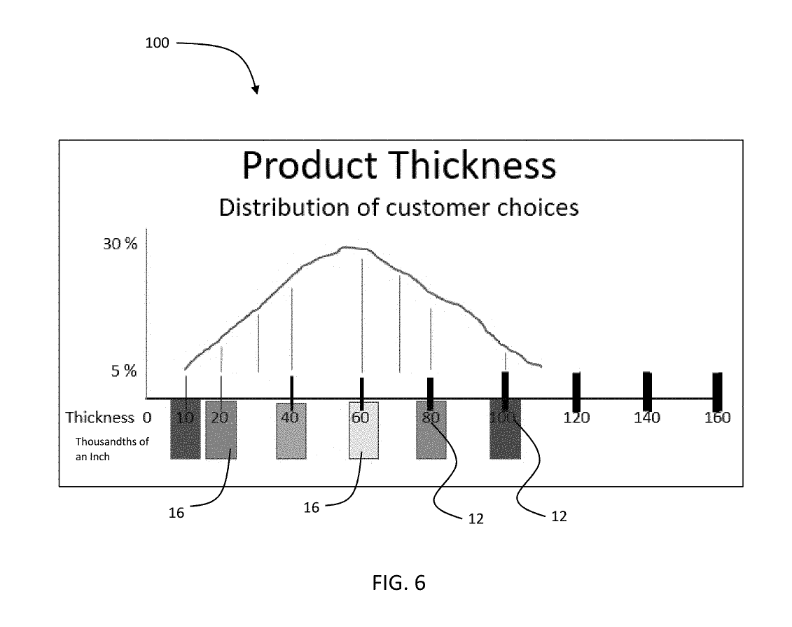

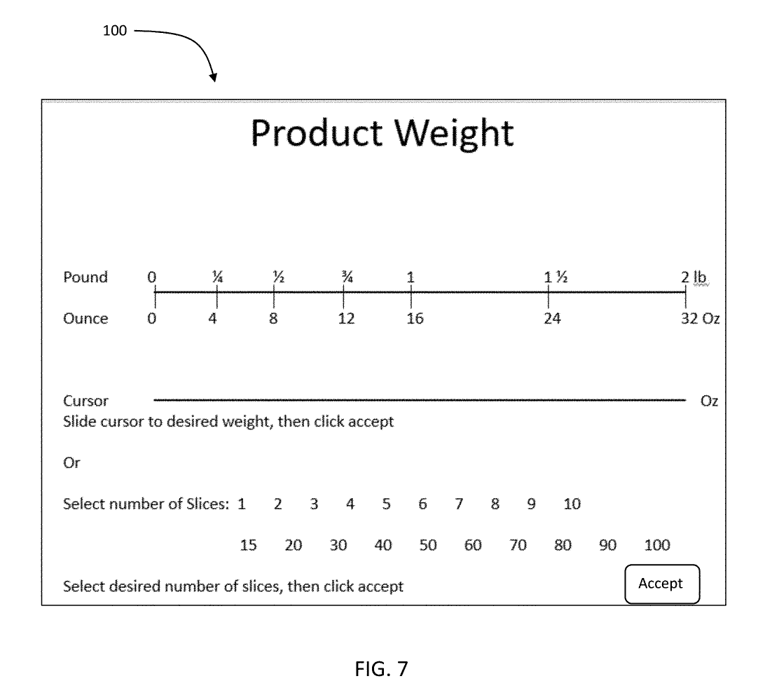

FIGS. 6 and 7 illustrate screens 100 displayed to customers when compiling an order. FIG. 6 shows a representative screen that permits selection of the slice thickness. In the embodiment shown in FIG. 6, screen 100 also shows data corresponding to the distribution of historical customer choices to compare the customer's order with what is most popular among people ordering at the store, within the system or among another population of customers. The customer may interact with the display by a touch screen or corresponding input device to select the thickness of the food product. The product thickness distribution data may be provided for individual food products and the customer may select the food product for which the data will be displayed. FIG. 7 shows screen 100 where a customer may interact by a touch screen or corresponding input device to select the weight or number of slices.

To complete the ordering system, it is desirable or even necessary to indicate to the customer that his/her order is in process, facing a problem or completed, so the problem can be clarified, or the order can be retrieved using the order number. For this purpose, an electronic order status board can be used showing order number and status as, for instance, in-process, experiencing a problem, or completed. It may also show the time the order was received and/or the expected completion time. It may also show where the order can be retrieved using the order number. When using a handheld electronic device to place the order, both the receipt and the completion of the order may be posted on the electronic device or announced on a public address system.

This invention may be enhanced by including a credit card payment system, by including options to stack slices directly on top of each other, or offset by a small distance like 0.25 inch, by providing an option to place paper sheets between slices. Other enhancements may include type of packaging options, attachment of a purchase slip with product name, weight, number of slices, date, price, operator, and/or barcode for any of these.

The method of saving time, money and aggravation while procuring sliced deli products can incorporate any combination of the described features incorporating an order number, an unambiguous description of product, an unambiguous description of product thickness desired, and the total weight or number of slices desired. It is further desirable for the customer to be informed when the order has been completed.

While the invention has been described in terms of specific or particular embodiments, it is apparent that other forms could be adopted by one skilled in the art. For example, the slice thickness gauges and their identifying features could differ in appearance and construction from the embodiments described herein and shown in the drawings, functions of certain components of the device could be performed by components of different construction but capable of a similar (though not necessarily equivalent) function, and appropriate materials could be substituted for those noted.

In addition, the invention encompasses additional or alternative embodiments in which one or more features or aspects of different disclosed embodiments may be combined. Accordingly, it should be understood that the invention is not necessarily limited to any embodiment described herein or illustrated in the drawings. It should also be understood that the phraseology and terminology employed above are for the purpose of describing the illustrated embodiments, and do not necessarily serve as limitations to the scope of the invention. Therefore, the scope of the invention is to be limited only by the following claims.

1. A method for purchasing sliced food products from an attendant at a store counter, the method comprising:
providing a slice thickness gauge to a customer, the slice thickness gauge having a plurality of identifying features each identifying feature corresponding to a thickness of a food product that may be produced by the attendant, the identifying features including a numeric value that is an integer devoid of fractions and decimal values and corresponds to a slice measurement that can be configured on a slicing machine;
communicating a customer selection to the attendant in the form of a slip, the slip including identification of the food product and the numeric value, wherein one or both of the slip and the thickness gauge include a representation of the slice thickness;
communicating an acceptance of the slip to the customer;
validating the order in response to the identification of the food product and the numeric thickness value;
communicating invalid orders to the customer;
configuring the slicing machine to slice the food product to a thickness corresponding to the numeric value;
slicing the food product to the thickness corresponding to the numeric value;
weighing and packaging the food product;
notifying the customer that the food product is ready for retrieval.

2. The method of claim 1, wherein the numerical value corresponds to thousandths of an inch.

3. The method of claim 1, wherein the slip is a paper slip.

4. The method of claim 1, wherein the slip is an electronic file generated on an electronic device.

5. The method of claim 1, wherein the identifying features further comprise bars displayed on the electronic device, and the bars are individually located within different color fields.

6. The method of claim 1, wherein the slip further includes a weight corresponding to a desired weight for the sliced food product, or the number of slices desired.

7. The method of claim 1, wherein the slip is an electronic file transmitted to a device readable by the attendant.

8. The method of claim 1, wherein the identifying features further include an independent color associated with the integer thickness number and slice thickness.

9. The method of claim 8, wherein the independent colors correspond to a color rainbow ranging from red representing the greater thickness to purple representing the lowest thickness.

10. The method of claim 1, wherein the notifying the customer includes generating an order number corresponding to the slip.

11. The method of claim 1, wherein the notifying the customer includes displaying the order number corresponding to the slip on a display board.

12. The method of claim 1, wherein the validating includes confirming that sufficient suitable food product is available to provide the sliced food product.

13. The method of claim 1, wherein the food product is retrieved from storage.

14. The method of claim 1, wherein the attendant is provided with a device to set the slice thickness on the slicing machine, the device being a micrometer, a slicing machine with a calibrated thickness dial, or a gauge similar to that provided for the customer.

15. The method of claim 1, further comprising providing the attendant with a system to convey messages to the customer related to acceptance of the order, problems with the order, and completion of the order.

16. The method of claim 1, wherein the product is sliced product sliced to a thickness accurately representing the customer's order.

17. The method of claim 1, further comprising, the weighing and packaging the food product, followed by verifying that the sliced food product corresponds to the slip.

18. The method of claim 1, further comprising returning unsliced food product to storage.

19. The method of claim 1, wherein the thickness gauge includes disks protruding from slots in a support, the disks including indicia representing the numeric value and at least one of colors, sizes, and logical order of the panels.

20. The method of claim 1, wherein the slice thickness gauge comprises a collection of rods secured to one another.

21. The method of claim 1, wherein the thickness gauge includes sheet panels loosely secured to one another, the sheet panels including indicia representing the numeric thickness value and at least one of colors, different sizes, and logical order of the panels.

22. The method of claim 1, wherein the thickness gauge includes stacks of sheet panels adhesively secured to one another, the sheet panels including indicia representing the numeric thickness value and at least one of colors, different sizes, and logical order of the panels.

23. The method of claim 22, wherein the sheet panels are disposable and the slice thickness gauge is configured for a single use.
